(19) United States
(12) Patent Application Publication
(10) Pub. No.: US 2014/0136480 A1
(43) Pub. Date: May 15, 2014

(54) FAST REPLICATION OF AN ENTERPRISE SYSTEM TO A REMOTE COMPUTING ENVIRONMENT

(71) Applicant: EPI-USE Systems, Ltd., Douglas (IM)

(72) Inventors: Phillip Stofberg, Roswell, GA (US); Christiaan Scheepers, Centurion (ZA)

(73) Assignee: EPI-USE Systems, Ltd., Douglas (IM)

(21) Appl. No.: 14/076,795

(22) Filed: Nov. 11, 2013

Related U.S. Application Data
(60) Provisional application No. 61/725,297, filed on Nov. 12, 2012.

(51) Int. Cl. G06F 17/30

(52) U.S. Cl. CPC G06F 17/30575
USPC 707/610

(57) ABSTRACT

Technologies for fast, automated replication of an enterprise system from a source computing environment to a target computing environment over a network are provided. A shell system is created by deploying a pre-installed system template in the target computing environment. Customer-specific data from the enterprise system in the source computing environment is exported and written to a set of files. The set of files are uploaded to an upload area of the target computing environment, and the files are imported into the shell system to create the replicated.

### CROSS-REFERENCE TO RELATED APPLICATIONS

This application is a continuation of U.S. Patent Application No. 61/725,297, filed Nov. 12, 2012, and entitled “FAST REPLICATION OF AN ENTERPRISE SYSTEM TO A REMOTE COMPUTING ENVIRONMENT,” the entire disclosure of which is hereby incorporated herein by this reference.

### BACKGROUND

Remote computing environments, such as managed hosting or cloud computing environments, provide cost saving opportunities and increased agility for large enterprises. To reap these benefits, an enterprise needs to move their enterprise systems, or copies thereof, to the remote computing environment. Enterprise systems, however, have large storage requirements with typical sizes ranging from tens or hundreds of gigabytes to multi-terabytes, while networks to remote computing environments typically have capacities of around 10 to 100 Mbits per second, which means that using conventional techniques may require several days when copying an enterprise system over a network to a remote computing environment.

Although enterprise systems may be copied for various reasons, the most common reasons for the need of copies are for development, prototyping, quality assurance and training. For all these purposes it is ideal to have real or representative data available. Most often, not all the data is required to perform these tasks, in which case a partial copy of the data is adequate. For example, historical data can be excluded and only recent data copied, or only data that represent a specific part of an organization may be required to be copied to a remote computing environment.

The task of copying the customer-specific application data, called data provisioning, may be application specific and need to take into consideration an organization's business processes and structures, and the volumes are very high, as mentioned. The steps involved in data provisioning may be, therefore, complex and time consuming. Copying an enterprise system from one environment to another, using conventional techniques over a network, may take a matter of weeks using regular technology.

The task of setting up an enterprise system, called system provisioning, is different. There are normally a limited number of combinations of operating system types, database management system types, and enterprise software products that have to be catered for. This means that, even though the system configuration is an involved process, there are fixed overarching principles and fixed patterns of how the system configurations looks like, that are known beforehand. Also, a newly installed system without application data generally comprises relatively small volumes (less than 100 GB). Still, setting up an enterprise system may be an involved process requiring the full attention of highly skilled and high cost technical people and may take more than a day to accomplish if not automated.

It is with respect to these and other considerations that the disclosure made herein is presented.

### SUMMARY

Technologies for fast, automated replication of an enterprise system from a source computing environment to a target computing environment over a network are provided herein. According to some embodiments, a method for replicating the enterprise system comprises deploying a pre-installed system template in the target computing environment to create a shell-system. Customer-specific data from the enterprise system in the source computing environment is then exported and written to a set of files. The set of files are uploaded to an upload area of the target computing environment, and the files are imported into the shell system to create the replicated enterprise system in the target computing environment.

According to further embodiments, a computer-readable storage media is encoded with computer-executable instructions that, when executed by a computer system, cause the computer system to deploy a pre-installed system template in the target computing environment to create a shell system. The pre-installed system template may comprise an operating system, an RDBMS, an enterprise system runtime kernel component, a delivered repository, and delivered configuration, but no customer-specific data. The customer-specific application data and configuration is exported from the enterprise system in the source computing environment and written to a set of files. The files are uploaded to an upload area of the target computing environment and then imported into the shell system to create a replicated enterprise system in the target computing environment.

According to further embodiments, a system comprises an export tool, an upload manager, and an import tool. The export tool is configured to select a subset of customer-specific application data from the enterprise system in the source computing environment, export the subset of the customer-specific application data and customer-specific configuration, and write the exported customer-specific application data and the customer-specific configuration to a set of files. The upload manager is configured to upload the set of files to an upload area of the target computing environment. The import tool is configured to import the set of files from the upload area into a shell system to create the replicated enterprise system in the target computing environment, the shell system created by deploying a pre-installed system template in the target computing environment.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a block diagram showing an illustrative operating environment for implementations of the embodiments described herein for replication of an enterprise system from a source environment over a network to a target environment.

FIG. 2 is a block diagram showing software and data components of an illustrative enterprise system, according to embodiments described herein.

FIG. 3 is a flow diagram showing one routine for replicating an enterprise system from a source computing environment to a target computing environment over a network, according to embodiments described herein.

FIG. 4 is a flow diagram showing a routine for creating a system template for the rapid deployment of a shell system, according to embodiments described herein.

FIG. 5 is a flow diagram showing additional details of deploying a pre-installed system template in the target computing environment as part of system provisioning, according to embodiments described herein.

FIGS. 6A and 6B are block diagrams showing additional details of software, hardware, and data components of the illustrative system environment, according to embodiments described herein.

FIG. 7 is a block diagram showing components of semantic extraction of data as part of the data exporting from the source system, according to embodiments described herein.

FIG. 8 is a block diagram showing details regarding document flow relationships and business object definitions, according to embodiments described herein.

FIG. 9 is a computer architecture diagram showing an illustrative computer hardware architecture for computing devices described in embodiments presented herein

### DETAILED DESCRIPTION

The following detailed description is directed to technologies for fast, automated replication of an enterprise system from a source computing environment to a target computing environment over a network. The replicated enterprise system may either be a full or partial copy of the source system. A productive enterprise system, also referred to herein as a customer system may comprise (1) customer-specific application data, which includes customer configuration, master data and transactional data, and (2) a set of generic components of the enterprise system, referred to herein as the software solution. The customer-specific application data may comprise by far most of the volume of the customer system. The term “customer” as used herein includes third parties, or subgroups, in the owner organization.

The methods and routines described herein involve the automation and optimization of the end-to-end replication process by using:
a) techniques to reduces the volume of data transferred and processed,
b) techniques to allow the most time consuming steps in the process to overlap and hence take place in parallel, and
c) A technique employing a combination of hardware and software solutions that allows for an exponential improvement in the time to build the replica system in the target environment, which typically constitutes the slowest step in the process.

The technologies provided herein address the major pain points encountered in this endeavor, specifically:
the time required to extract a subset of data from an enterprise system, the source system, given the high volumes of data involved;
relative limited bandwidth of networks to remote computing environments; and
the time required to build a new enterprise system, the target system, which may be a lower performance system than the source system. This installation of a new system may require manual intervention and the import of the source data is in general processing intensive.

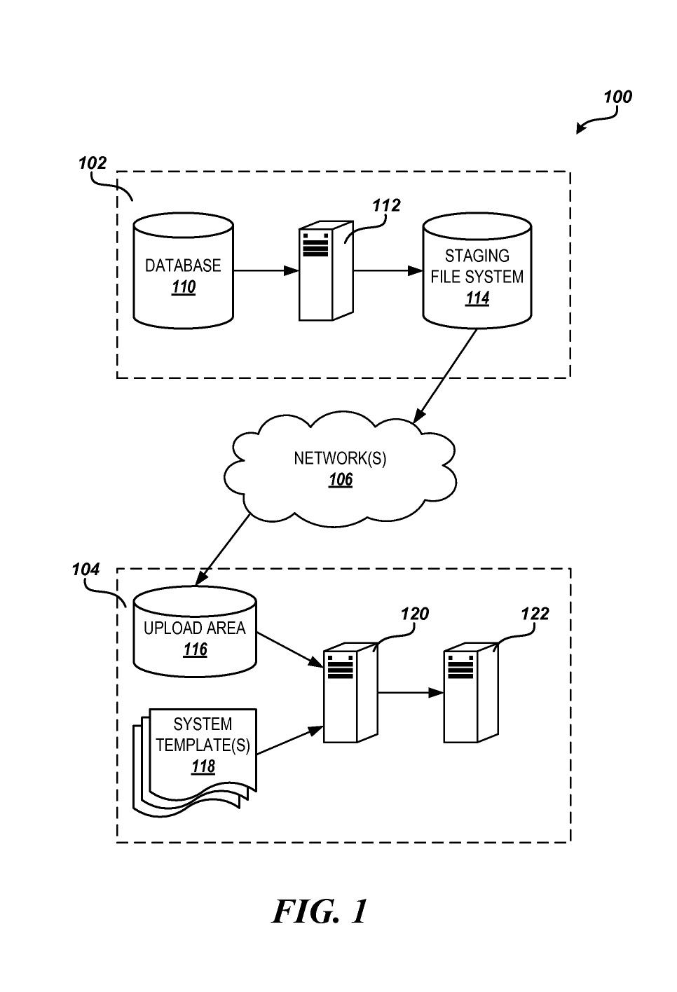

FIG. 1 provides an illustrative operating environment 100 for implementations of the embodiments described herein. According to embodiments, some methods comprise replicating one or more enterprise systems from a source computing environment 102 to a target computing environment 104, accessible through one or more networks 106. In some embodiments it can be copied to a public cloud computing environment separated from the source computing environment by a network. The source computing environment 102 may include a source system database 110 that defines the data, configuration, and functionality of the enterprise system. The source computing environment 102 may further include one or more application servers, such as application server 112, that executes software programs that export the data, configuration, and functionality of the enterprise system from the source system database 110 to a number of files in a staging file system 114. From the staging file system 114, the files can be transmitted across the network(s) 106 to an upload area 116 in the target computing environment 104. Utilizing the transferred files in the upload area 116 and one or more system templates 118, a partial or full replica of the enterprise system can be deployed to a spin-up system 120 comprising high-performance hardware, according to some embodiments. Once the replica of the enterprise system is deployed in the spin-up system 120, the enterprise system can be migrated to a longer term operating environment 122, as will be described herein.

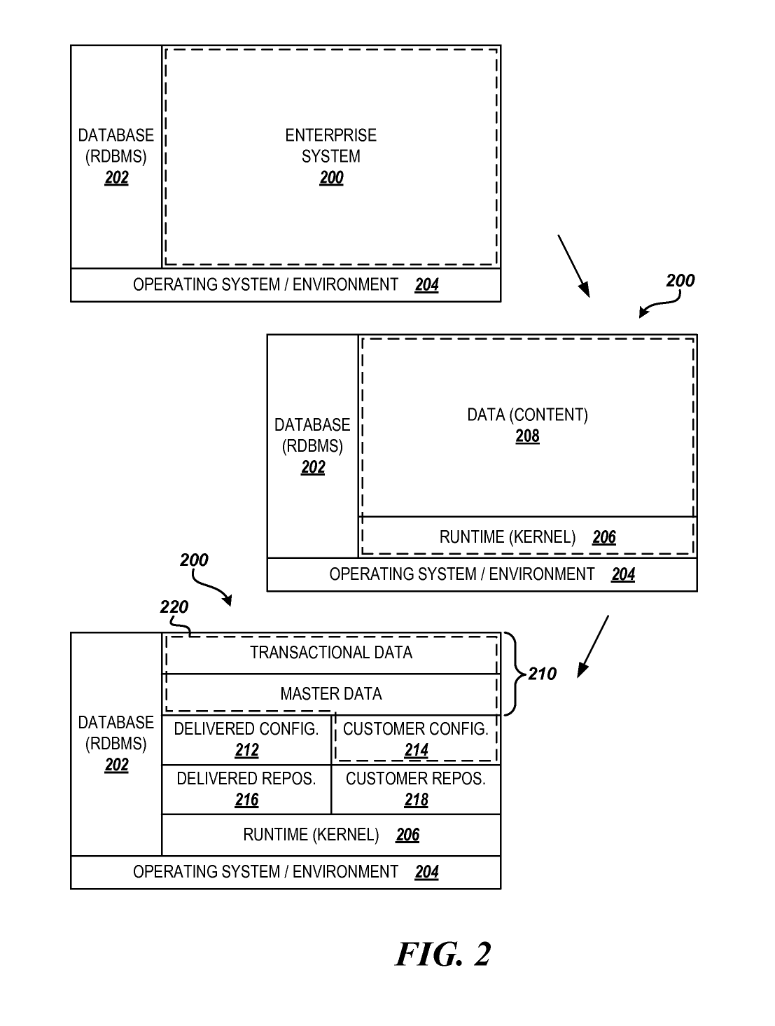

FIG. 2 provides an overview of the components of an illustrative enterprise system 200, according to some embodiments. The enterprise system 200 may comprise one or more of the following components: an operating system 204, a relational database management system (“RDBMS”) 202 that may contain system-specific database logic, an enterprise system runtime kernel component 206 that may be spread over several application servers or other computer platforms, a delivered repository 216 and a customer-specific repository 218, delivered configuration 212 and customer-specific configuration 214, and application data 210. According to some embodiments, the enterprise system 200 may comprise SAP® enterprise software from SAP AG of Waldorf, Germany. Since enterprise systems may differ and technologies develop, these components may be combined or replaced in different brands of enterprise systems. The following descriptions are used to describe certain functionality, which may be available in an embodiment and is intended as an example to explain the current disclosure. The current disclosure is not dependent on all of the components being present, and additional components may be added without affecting the current disclosure.

The RDBMS 202 may comprise the software code supporting the database query language and governing the maintenance of the particular database model. The relational database model is a commonly used data model.

The runtime kernel component 206 of the enterprise system 200 may in some embodiments be comprised of a standard delivered enterprise software configuration, plus standard delivered application code that is executed by the runtime kernel, which executes directly on the operating system 204 software. The runtime kernel component 206 provides an abstraction layer that hides the complexity or variations in the services offered by the operating system 204. According to some embodiments, the runtime kernel component 206 may comprise the JAVA® Runtime Environment from ORACLE® Corporation of Redwood City, Calif. In some embodiments the runtime kernel component 206 may handle interfacing with the operating system 204, networking software and the RDBMS 202.

In some embodiments, such as in SAP® systems, the runtime kernel component 206 may include an interpreter, in which case the application data 210 may include a part of the executable enterprise code and such data that comprises software program code may be stored in database tables in the RDBMS 202. The repositories 216 and 218 may comprise program code and structures executed by the runtime kernel component 206, as well as metadata and data dictionary information and the like.

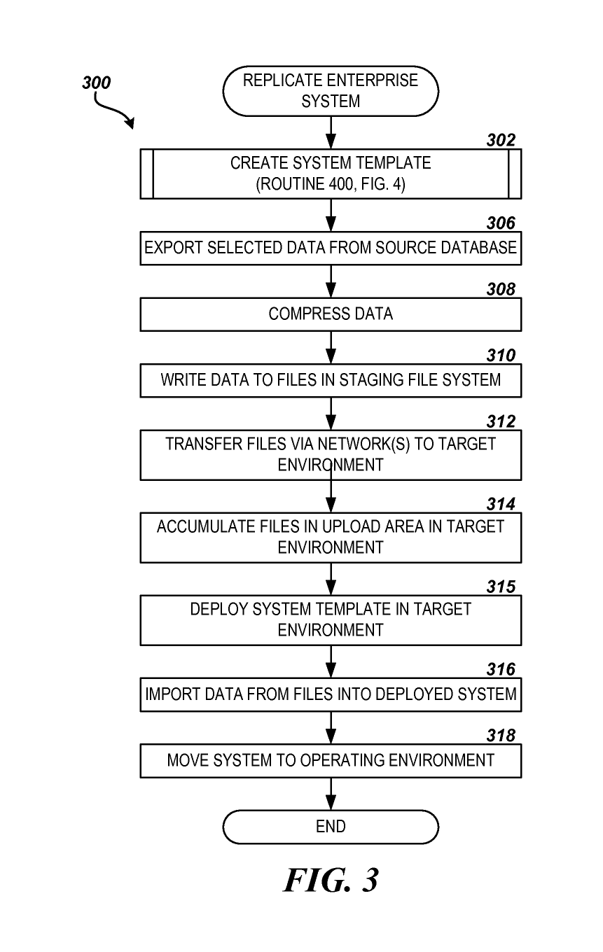

FIG. 3 illustrates one routine 300 for replicating an enterprise system 200 from a source computing environment 102 over the network(s) 106 to a target computing environment 104, according to embodiments described herein. Deploying an enterprise system 200 in a new computing environment 104 comprises a comprehensive and time consuming process involving multiple manual steps. To simplify and speed up this task, a system not containing any customer-specific application, customization, and configuration, e.g. including the operating system 204, the RDBMS 202, and the runtime kernel component 206, may be stored as a pre-installed system template 118 in some embodiments and rapidly deployed when required.

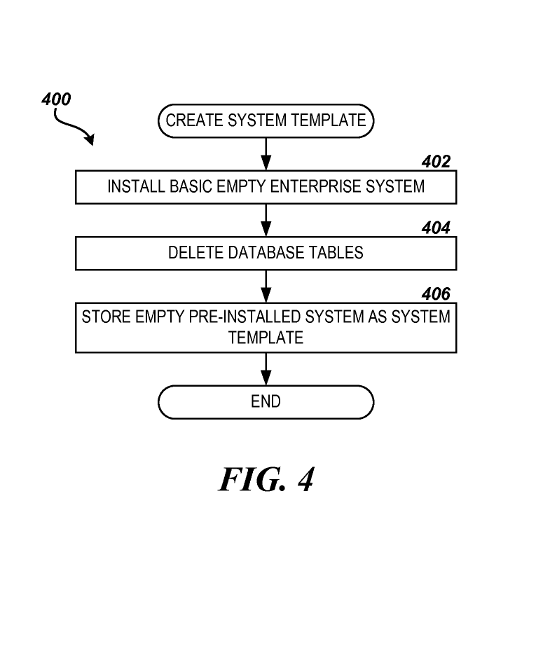

As a first step of the replication routine 300, one or more pre-installed system templates 118 are created for the target computing environment 104, as shown at step 302. This may be done using a routine 400 such as that shown in FIG. 4, according to some embodiments. As utilized herein, a “basic empty enterprise system” may refer to a default or standard system installation without any customer-specific configuration 214, customer-specific repository 218, and application data 210. In some embodiments, the basic empty system installation may comprise the operating system 204, the RDBMS 202, an enterprise system runtime kernel component 206, a delivered repository 216, and delivered configuration 212. Delivered items 212 and 216 refer to those provided by the enterprise software vendor, such as SAP®.

As shown in step 402, a basic empty enterprise system 200 is installed on a reference computer system, and all the database tables related to the vendor provided delivered repository 216 and delivered configuration 212 are deleted, as shown at step 404. Next, at step 406, the pre-installed system is imaged and stored as a system template 118. The term “pre-installed” is used to indicate that the system template 118 contains a partial installation and does not constitute an executable system, and needs additional components, which may include the delivered repository 216 and delivered configuration 212 components. A system template 118 may comprise a single virtual machine image or several virtual machine images over which various enterprise system components are spread. In some embodiments the pre-installed system templates 118 are stored in the target computing environment 104 for use when required, as shown in FIG. 1.

Intricate knowledge of the typical patterns of use, of enterprise systems in general and particular database/operating system/enterprise system product version combinations, allow an expert knowledgeable in the field to fine tune and tweak the system parameters for each system template 118 to ensure good performance. The manual intervention of skilled technicians may thereby be eliminated. This reduces the cost of manual intervention and supports a process that increases the likelihood of superior performance. Such system parameters include but are not limited to:
Operating system and environment 204:
   Physical hardware configuration (e.g. number of CPUs, number of cores of CPU, speed, amount of RAM, I/O subsystem)
   Virtual hardware configuration (e.g. type of virtual hardware, number of CPUs, etc.)
   Network configuration (e.g. network bandwidth, latency, throughput required)
   OS level configuration (ratios of RAM/CPU/storage/swap space allocated)
RDBMS 202:
   Sizing parameters
   Tuning parameters
   Indexing parameters
   Backup schedule definition
Runtime kernel component 206 of the enterprise system 200:
   Various kernel parameters
   Specification of components and versions (including provision for dependencies between versions)
   Configuration of 3rd party components as required
   JAVA® VM version and runtime parameters and settings
   Configuration of integration to other systems in a landscape of systems

In some embodiments, the runtime kernel component 206 and/or application independent software may be updated by the vendor from time to time, which implies that the system templates 118 may have to be updated on a regular basis, reducing human intervention required at the time of deployment. Utilizing system templates 118 configured for various hardware platforms and configurations, enterprise systems 200 may be replicated between different hardware platforms. This may be done for various reasons including lower cost and/or testing on different platforms. For example, an enterprise system 200 running on IBM AIX with IBM DB2 may be copied to a target system running on ORACLE® and RHEL. In some embodiments, system templates 118 may be created for the most common or frequently used combinations of hardware platforms and configurations used in the industry. The method thus supports a heterogeneous system replication strategy.

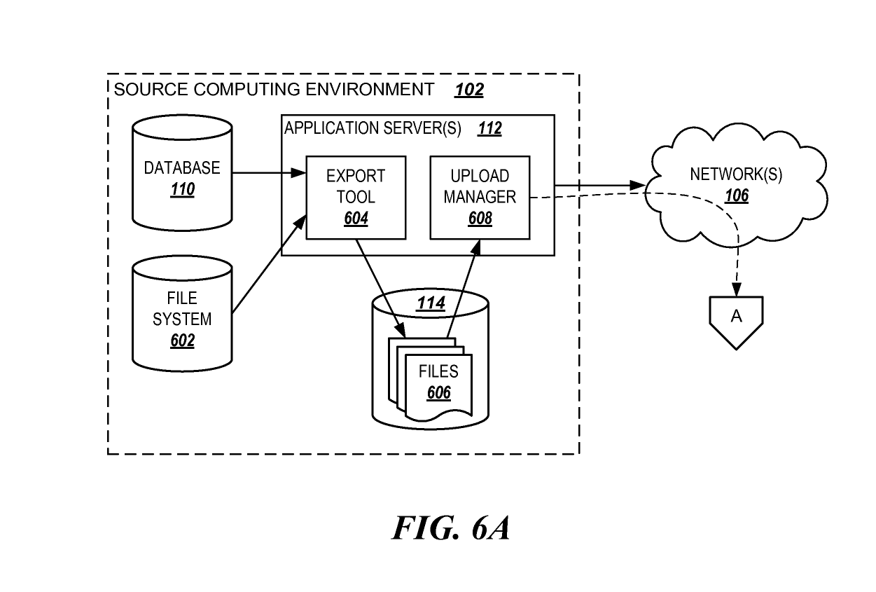

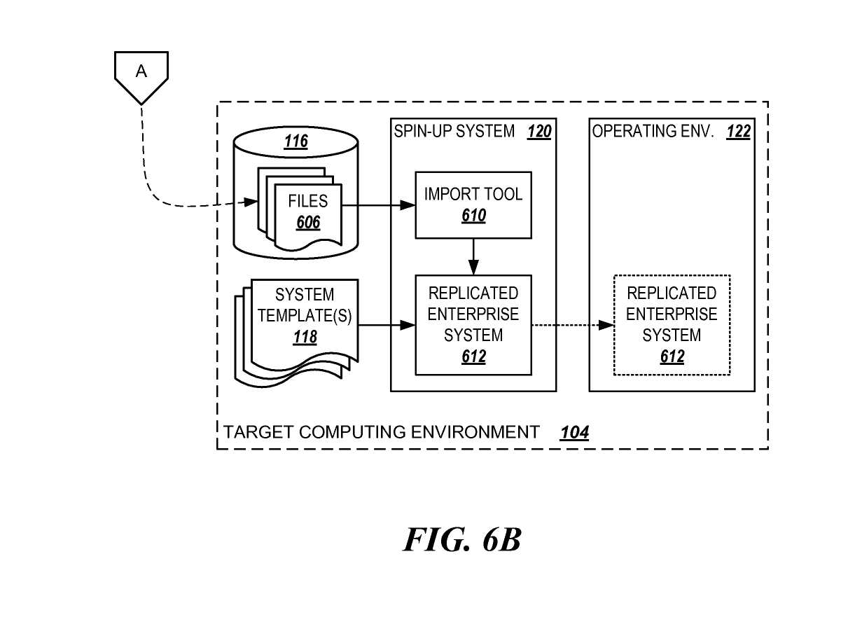

Returning to FIG. 3, the routine 300 may proceed from step 302 to step 306, where at least a portion of the data (content) 208 is exported from the enterprise system in the source computing environment 102. The exported data (content) 208 may be optionally compressed and written to a series of files in the staging file system 114 to be transferred to the target computing environment 104. This process may be referred to as “data provisioning.” As shown in FIGS. 6A and 6B, the data provisioning process may comprise initiating an export tool 604 in the source computing environment 102. The export tool 604, which in some embodiments may be running on an application server 112, may export selected data from the source system database 110 and file system 602 residing on one or more database servers in the source computing environment 102. The export tool 604 may perform the following steps:
extract selected customer-specific application data 210 and customer-specific configuration 214 (step 306). According to some embodiments, this may also include customer-specific programs, database structures, database table definitions, etc., native to the enterprise system 200, collectively referred to as customer specific-data 220 as shown in FIG. 2;
compress the data (step 308), according to some embodiments; and
write the extracted data, which may be compressed or non-compressed, to files 606 in the staging file system 114 (step 310).

The export tool 604 may require knowledge of the data structures, in order to read the required data, for example, when accessing database tables. In some embodiments, the export tool 604 may call vendor provided utilities, which have knowledge of the architecture of the enterprise system 200, to retrieve the data items. In some embodiments, a subset of the customer-specific data 220 may be selected for extraction on the basis of business processes rather than structural relationships. The selective copying of data may require non-sequential surgical selection and retrieval of data records, taking into consideration said business process-related, structural, technical, and other dependencies between data records. For example, if data item A is dependent on data item B (or vice versa), the selection process would ensure that both A and B are included in the selection.

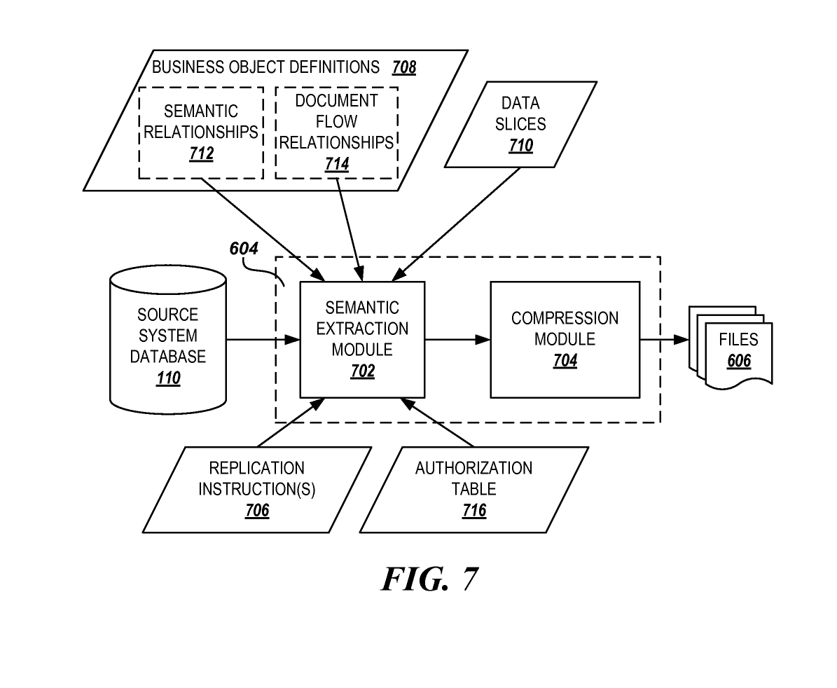

In some embodiments, the export tool 604 may include a semantic extraction module 702 and a compression module 704, as shown in FIG. 7. The semantic extraction module 702 may have the capability of extracting subsets of data on the basis of the non-sequential surgical selection of data records, taking into account the dependencies. In an embodiment, the semantic extraction module 702 may read replication instruction(s) 706 which has been composed by a system user. The replication instruction(s) 706 may specify the business objects or tables to be extracted. The semantic extraction module 702 may then apply semantic selection to extract data from the source system database 110.

Semantic selection may comprise data selection based on a combination of business object definitions 708 and data slices 710. Data slices 710 may comprise selection criteria like a time period, a single or set of company codes in the case of a multi company organization, or other combinations of ranges of variables typically found in database queries. The business object definitions 708 comprise data structure definitions and executable procedures that operate on the data. A data structure definition comprises a list of database table definitions. A database table definition may comprise a list of field names and may include one or more pointers to other fields in other tables and other business objects. The business object definitions 708 thus contain chains of pointers where one field in a data table contains a pointer to another field in another table, which in turn contains a pointer to another record in yet another table, relating business objects to one another.

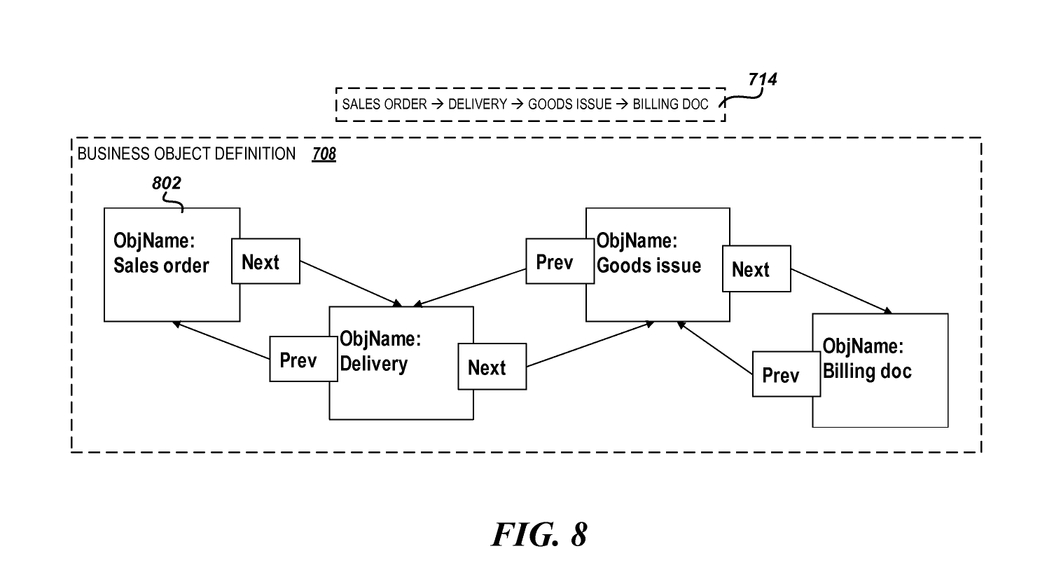

The business object definitions 708 may include semantic relationships 712 and document flow relationships 714. A document flow relationship 714 embodies a business process and may comprise a sequence of business objects 802 that may form part of a business transaction, as shown in FIG. 8. In some embodiments, document flow relationships 714 may include related business objects that reside in other enterprise systems. A semantic relationship 712 refers to a set of things that may be related on the basis of their function, role or use, like the various components of a mechanical device, or the items in a first-aid kit. The semantic extraction module ensures data integrity, by ensuring that if a specific period of time (i.e. a date range) has been specified in the replication instruction(s) 706 and/or data slices 710, all documents in a document flow relationship 714 are copied, even if the date of a specific document is outside the specified time period. This allows all documents necessary to process a document flow scenario during development, quality insurance, or the like to be included in the replication process to the target computing environment 104. Similarly, the semantic extraction module 702 not only copies the specified business objects 802 but ensures that all related business objects are replicated as well, based on the business object definitions 708.

According to further embodiments, the semantic extraction module 702 may also ensure that only data fields for which the system user has an adequate level of authority are replicated. Each data object may have a required authorization level and each user may have an authorization level contained in an authorization table 716, which may be contained in the source system database 110.

Depending on the selection criteria, the semantic extraction module 702 may reduce the total volume by up to an order of magnitude. In other embodiments the extraction may comprise all the customer-specific application data 210 and some configuration 214. In further embodiments the extraction may comprise a selection of data, based on a query defined by the user. In the case of enterprise systems 200 containing an interpreter in the runtime kernel component 206, the extracted data may include executable program code. In some embodiments, the extracted data may be compressed by the compression module 704, as described at step 308 in FIG. 3, to further reduce the size by another order of magnitude.

The routine 300 may proceed from step 308 to step 310. where the export tool 604 writes the extracted data to a series of files 606 in the staging file system 114. The staging file system 114 may be a designated storage area in the source computing environment 102 where the files 606 containing extracted and exported data may be temporarily stored until being transmitted to the target computing environment 104. In some embodiments the splitting of the extracted data into files 606 may be according to data base table structures or other structures. In other embodiments the splitting of the extracted data into files may happen on a system level, irrespective of the specific data structures involved. The size of the files 606 with compressed data may be of small to medium size in some embodiments, and may vary between 40 MB to 1 GB, but the size may be bigger or smaller. According to some embodiments, parallel processing may be used to write the files 606 to the staging file system 114.

From step 310, the routine 300 proceeds to step 312, where an upload manager 608 in the source computing environment 102 copies or transmits the files 606 in the staging file system 114 over the network(s) 106 to the upload area 116 in the target computing environment 104. The upload manager 608 may be a computer software program which may continuously repeat the following cycle:
monitor whether there are files 606 which the export tool 604 has completed writing in the staging file system 114; and
transmit the files 606 to the upload area 116 in the target computing environment 104 via the network(s) 106 as the files become available.

In some embodiments the files 606 may be copied to the target computing environment 104. In other embodiments, the files 606 may be copied to a virtualized cloud environment. In some embodiments, the files 606 may be transmitted by the upload manager 608 in parallel transfer streams over the network(s) 106. A limit may be put on the number of parallel transfer streams used during the transfer process at a given point in time. In some embodiments the upload manager may run on the same application server 112 as the export tool 604, or on a separate server. In further embodiments, the source system database 110, file system 602, staging file system 114, export tool 604, and upload manager 608, may be on the same or on different application server(s) 112.

After the first file 606 has been exported by the export tool 604, the transfer process may be started immediately. In other words, the upload manager 608 may start transmitting each file 606 once exported, while the export tool 604 is exporting the next set of files. In this way, several individual files 606 may be transferred in parallel. The files 606 may be transmitted concurrently over different routes on the network(s) 106. The export/upload process can be faster or slower than the transfer process. Therefore, the staging file system 116 may be used as a buffer. Since files 606 are managed individually, they need not arrive in sequence. If a communication failure occurs, just the file transmission(s) in process may be lost and need to be restarted, without affecting the transmission of the other files. The upload area 116 may be designated storage area 260 in the target computing environment 104 where transferred files 606 may be temporarily accumulated until all files from the source computing environment 102 have been transmitted, as shown at step 314.

From step 314, the routine 300 proceeds to step 315, where the pre-installed system template 118 without database tables is deployed in the target computing environment 104 creating a shell system that will host the replicated enterprise system 612, as described below. A shell system refers to an operational system without application data. In some embodiments, the shell system may comprise the pre-installed template plus the repositories and configuration. Whereas the pre-installed template cannot run by itself, the shell system can. According to some embodiments, arrival of the files 606 in the upload area 116 of the target computing environment 104 may initiate deployment of the pre-installed system template 118 on the spin-up system 120.

Deployment of the pre-installed system template 118 may include creating of a new virtual machine from the template on the spin-up system 120. The deployed components of the shell system may include the runtime kernel component 206 and the RDBMS 202, as well as the delivered repository 216 and delivered configuration 212. The delivered repository 216 and delivered configuration 212 components may be imported from the source computing environment 102, according to some embodiments. The shell system may also include the customer-specific repository 218 and/or some portions of the customer-specific configuration 214.

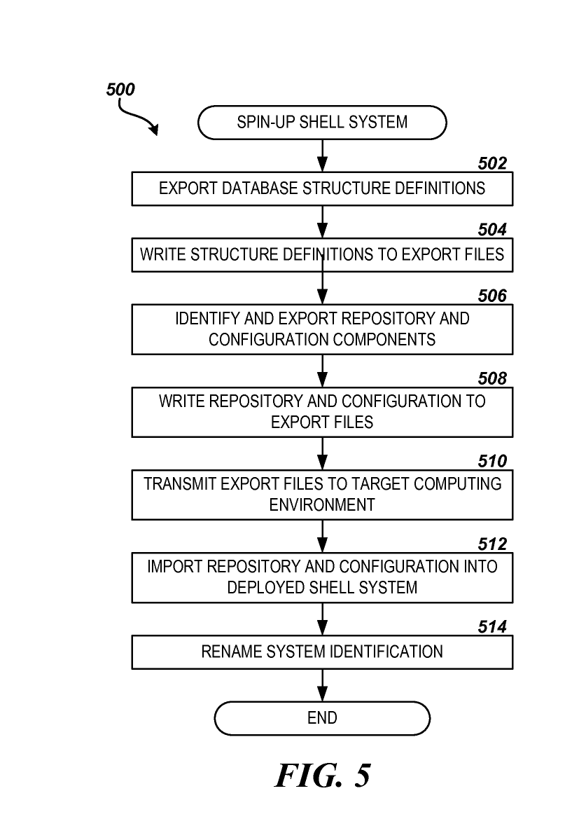

A system building tool may be utilized to export the repositories 216 and 218 and/or configuration 212 and 214 from the source system, using a procedure or routine 500 as shown in FIG. 5. According to some embodiments, the system building tool may export database structure definitions for all tables related to the enterprise system 200 in the source system database 110, as shown at step 502. Next, at step 504, the exported database structure definitions may be written to a set of export files. The system building tool may then identify and export the repositories 216 and 218 and the configuration 212 and 214 from the enterprise system 200 in the source computing environment 102, and write them to the export files, as shown at steps 506 and 508. The repositories 216 and 218 and the configuration 212 and 214 may include executable enterprise code, database structures, database table definitions, and the like. In some embodiments, the executable enterprise code may include programs such as table viewers, database maintenance reports, development utilities, and the like.

The exported files may then be transmitted to the target computing environment 104, as shown at step 510. The transmission of the export files to the target computing environment 104 may be performed by the upload manager 608 along with the files 606 as part of the data provisioning process described above in regard to steps 312-314. The transferred export files may then be imported into the shell system created from the pre-installed system template 118 in order to incorporate the source system exported repository components 216 and 218, the source system exported delivered configuration 212 and some customer-specific configuration 214, as shown in step 512. In some embodiments wherein SAP® software is used, the importing into the shell system may be performed using a low level SAP tool called R3load. The R3load tool may be executed for each component exported from the source system database 110 by the system builder tool in step 508. The R3load tool may read the file names from a command file, perform the imports, and log the operations. Once importing has been completed, the system building tool may be used to rename the system identification of the newly created shell system to differentiate it from the enterprise system 200 executing in the source computing environment 102, as shown at step 514.

Returning to FIG. 3, once the shell system has been deployed, the routine 300 proceeds from step 315 to step 316, where an import tool 610 imports the transferred files 606 into the shell system deployed in the spin-up system 120 to create the replicated enterprise system 612. In some embodiments, the upload manager 608 may notify the import tool 610 via a web service when the last of the files 606 has been uploaded to the upload area 116. In other embodiments the import tool 610 may maintain a record of the files 606 which have been transferred to the upload area 116, and the import processing may start after the transmission of the first one or more files has been completed. Since importing may be substantially faster than the file transfer, importation may be delayed until transfer of the files 606 to the upload area 116 has been completed, according to some embodiments.

In some embodiments, the import tool 610 may perform the following actions upon detection of a new file 606 in the upload area 116, or upon reception of a notification from the upload manager 608:
monitor and record the completed transmission of individual files 606 in the upload area 116;
initiate the deployment of a system template 118 (step 315);
read the files 606 uploaded to the upload area 116 in sequence;
decompress the data in the files 606 if required;
insert the application data 210 and/or some customer-specific configuration 214 contained in the files 606 into the RDBMS of the shell system deployed on the spin-up system 120; and
stop when it detects a “last file” flag, in some embodiments, or receives a web service call indicating the same, in an embodiment.

According to some embodiments, the import tool 610 may require knowledge of the data structures, for example, database tables or business objects or other metadata, in order to insert the data correctly. According to embodiments, this information may be available in the customer-specific repository 218 and configuration 214 which were transferred to the target computing environment 104 as part of the system template deployment described above in step 304. In some embodiments, the import tool 610 may call vendor provided utilities that have knowledge of the architecture of the target system to insert the data appropriately. In some embodiments, some of the functions of the import tool 610 may be split off into a separate computer software program running on the same or on one or more separate application servers 112.

In some embodiments, the export tool 604 may use a notification technique to inform an import tool 610 that importing of files can be initiated. In some embodiments of the notification technique, the last of the files 606 may be prefixed with a flag, indicating that it is the last file. In some embodiments, each of the files 606 may be pre-fixed with a number, indicating the sequence in which the files need to be read as well as a flag indicating whether the file content is part of system provisioning or of data provisioning. In some embodiments the system provisioning and data provisioning files 606 may be transmitted in two separate batches, that are identified by means of a label attached to the front of each batch. In some embodiments, the sets of files 606 may be identified according to the system component they belong to, such as the delivered repository 216, the customer-specific repository 218, the delivered configuration 212, the customer-specific configuration 214, and the application data 210.

As described above, the import tool 610 may also initiate the deployment of the pre-installed system template 118 in the spin-up system 120. Having the import tool 610 automatically deploy the correct system template 118 to the spin-up system 120 may eliminate the process of going through a manual, multiple-step enterprise system installation, which may require substantial human intervention. A number of variables may be involved in the selection of a system template 118 for creating the shell system, including, but not limited to:
the choice of operating system 204 type and version;
the choice of RDBMS 202 type and version; and/or
the choice of enterprise system 200 product brand and version.

The selection of the system template 118 to use to create the shell system may be specified by means of the mentioned notification technique described above. For example, the prefix of the last of the files 606 may further include a code specifying the system template 118 (e.g. operating system, database, and enterprise product brand combination) which should be used to deploy the shell system for the given set of files 606. In other embodiments the specification of the system template 118 may be pre-fixed to the first of files 606. In further embodiments, the notification technique may comprise a web service call to the spin-up system 120, and the notification of the specification of the system template 118 may occur at an earlier or other appropriate stage. In some embodiments, the data exported may be independent of the types of the RDBMS 202 and/or operating system 204. In this embodiment, the user may select a system template 118 corresponding to a different combination of RDBMS/operating system types than the source system, and may select from a predefined list of options corresponding to the available templates.

According to further embodiments, the spin-up system 120 may employ high performance storage hardware. The high performance storage may comprise flash storage based drives, such as solid-state drives (SSDs), or other performance enhancing hardware or software solutions. In some embodiments the spin-up system 120 may comprise multiple systems of different sizes. A spin-up system 120 may be graded in terms of its size, expressed in terms of the number of terabytes, or it may be graded in terms of its performance as supported by the SSDs, etc. In further embodiments, multiple systems of multiple clients may be in the process of being imported or being hosted in the target computing environment 104.

According to further embodiments only the enterprise system database may be moved to the high performance storage. If the size of the spin-up system database exceeds the size available in the high performance storage, tables used with a low frequency may be saved in a cache on regular storage hardware. The use of a high performance storage spin-up system 120 exploits the high TOPS (Input Output Operations Per Second—used as a performance measure for storage solutions) provided by flash based storage devices, such as SSDs, or similar high performance hardware to aid in the IO intensive installation and data load processes.

Once the importing has been completed, the routine 300 proceeds from step 316 to step 318, where the now complete replicated enterprise system 612 may be migrated 380 from the high performance spin-up system 120 to the longer term operating environment 122 in the target computing environment 104. The longer term operating environment 122 may comprise a traditional Storage Area Network (SAN) in some embodiments. In further embodiments, a server may connect to the SAN using Fiber Channel (FC) or iSCSI protocols. A SAN provides a solution wherein multiple servers may access the same storage.

In some embodiments, the migration may be performed by shutting down the replicated enterprise system 612, transferring the constituent files to the longer term operating environment 122 using the file system, and then starting the system again in the operating environment. In other embodiments, the migration may be done using virtualization techniques. For example, the replicated enterprise system 612 may be suspended; the image physically copied to the hardware of the longer term operating environment 122, and the system resumed. Another virtualization technique may comprise modern virtualization techniques supporting live migrations.

Under a normal system load, a lower TOPS environment may be sufficient for hosting the replicated enterprise system 612. The fast platform used during importing may not provide the redundancy benefit provided by normal enterprise storage solutions, but does provide an exponential performance benefit on a temporary basis during the importing stage where redundancy is not required. This technique provides a trade-off by using the high-speed storage platform only when needed. In some embodiments the high-speed platform may be shared by multiple remote systems. In other embodiments, the replicated enterprise system 612 may remain on the high-performance spin-up system 120.

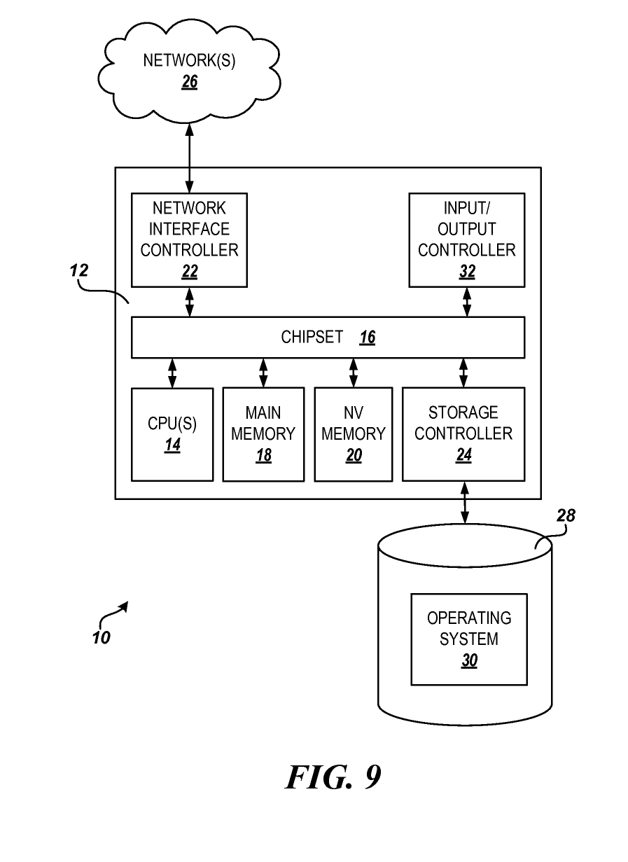

FIG. 9 shows an illustrative computer architecture 10 for a computer 12 capable of executing the software components described herein for performing replication of an enterprise system from a source computing environment 102 to a target computing environment 104 over the network(s) 106, in the manner presented above. The computer architecture 10 shown in FIG. 12 illustrates a conventional server computer, workstation, desktop computer, network appliance, or other computing device, and may be utilized to execute any aspects of the software components presented herein described as executing on application servers 112, spin-up system 120, operating environment 122, or other computing platforms.

The computer 12 includes a baseboard, or “motherboard,” which is a printed circuit board to which a multitude of components or devices may be connected by way of a system bus or other electrical communication paths. In one illustrative embodiment, one or more central processing units (“CPUs”) 14 operate in conjunction with a chipset 16. The CPUs 14 are standard programmable processors that perform arithmetic and logical operations necessary for the operation of the computer 12.

The CPUs 14 perform the necessary operations by transitioning from one discrete, physical state to the next through the manipulation of switching elements that differentiate between and change these states. Switching elements may generally include electronic circuits that maintain one of two binary states, such as flip-flops and electronic circuits that provide an output state based on the logical combination of the states of one or more other switching elements, such as logic gates. These basic switching elements may be combined to create more complex logic circuits, including registers, adders-subtractors, arithmetic logic units, floating-point units or the like.

The chipset 16 provides an interface between the CPUs 14 and the remainder of the components and devices on the baseboard. The chipset 16 may provide an interface to a random access memory (“RAM”) 18, used as the main memory in the computer 12. The chipset 16 may further provide an interface to a computer-readable storage medium such as a read-only memory (“ROM”) 20 or non-volatile RAM (“NVRAM”) for storing basic routines that help to startup the computer 12 and to transfer information between the various components and devices. The ROM 20 or NVRAM may also store other software components necessary for the operation of the computer 12 in accordance with the embodiments described herein.

According to various embodiments, the computer 12 may operate in a networked environment using logical connections to remote computing devices and computer systems through one or more networks 26, such as a local-area network (“LAN”), a wide-area network (“WAN”), the Internet or any other networking topology known in the art that connects the computer 12 to remote computers. The chipset 16 includes functionality for providing network connectivity through a network interface controller (“NIC”) 22, such as a gigabit Ethernet adapter. It should be appreciated that any number of NICs 22 may be present in the computer 12, connecting the computer to other types of networks and remote computer systems.

The computer 12 may be connected to a mass storage device 28 that provides non-volatile storage for the computer. The mass storage device 28 may store system programs, application programs, other program modules and data, which are described in greater detail herein. The mass storage device 28 may be connected to the computer 12 through a storage controller 24 connected to the chipset 16. The mass storage device 28 may consist of one or more physical storage units. The storage controller 24 may interface with the physical storage units through a serial attached SCSI (“SAS”) interface, a serial advanced technology attachment (“SATA”) interface, a fiber channel (“FC”) interface or other standard interface for physically connecting and transferring data between computers and physical storage devices.

The computer 12 may store data on the mass storage device 28 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 28 is characterized as primary or secondary storage, or the like. For example, the computer 12 may store information to the mass storage device 28 by issuing instructions through the storage controller 24 to alter the magnetic characteristics of a particular location within a magnetic disk drive unit, the reflective or refractive characteristics of a particular location in an optical storage unit, or the electrical characteristics of a particular capacitor, transistor or other discrete component in a solid-state storage unit. Other transformations of physical media are possible without departing from the scope and spirit of the present description, with the foregoing examples provided only to facilitate this description. The computer 12 may further read information from the mass storage device 28 by detecting the physical states or characteristics of one or more particular locations within the physical storage units.

In addition to the mass storage device 28 described above, the computer 12 may have access to other computer-readable medium to store and retrieve information, such as program modules, data structures or other data. It should be appreciated by those skilled in the art that computer-readable media can be any available media that may be accessed by the computer 12, including computer-readable storage media and communications media. Communications media includes transitory signals. Computer-readable storage media includes volatile and non-volatile, removable and non-removable storage media implemented in any method or technology for the non-transitory storage of information. For example, computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY or other optical storage, magnetic cassettes, magnetic tape, magnetic disk storage or other magnetic storage devices and the like.

The mass storage device 28 may store an operating system 30 utilized to control the operation of the computer 12. According to some embodiments, the operating system comprises the LINUX operating system. According to other embodiments, the operating system comprises the WINDOWS° SERVER operating system from MICROSOFT Corporation of Redmond, Wash. According to further embodiments, the operating system may comprise the UNIX or SOLARIS operating systems. It should be appreciated that other operating systems may also be utilized.

The mass storage device 28 may store other system or application programs and data utilized by the computer 12 as described herein. In some embodiments, the mass storage device 28 or other computer-readable storage media may be encoded with computer-executable instructions that, when loaded into the computer 12, may transform the computer from a general-purpose computing system into a special-purpose computer capable of implementing the embodiments described herein. These computer-executable instructions transform the computer 12 by specifying how the CPUs 14 transition between states, as described above.

The computer 12 may also include an input/output controller 32 for receiving and processing input from a number of input devices, such as a keyboard, a mouse, a touchpad, a touch screen, an electronic stylus or other type of input device. Similarly, the input/output controller 32 may provide output to a display device, such as a computer monitor, a flat-panel display, a digital projector, a printer, a plotter or other type of output device. It will be appreciated that the computer 12 may not include all of the components shown in FIG. 12, may include other components that are not explicitly shown in FIG. 12, or may utilize an architecture completely different than that shown in FIG. 12.

Based on the foregoing, it should be appreciated that technologies for fast, automated replication of an enterprise system from a source computing environment to a target environment over a network are presented herein. Although the subject matter presented herein has been described in language specific to computer structural features, methodological acts and computer readable media, it is to be understood that this disclosure is not necessarily limited to the specific features, acts or media described herein. Rather, the specific features, acts and mediums are disclosed as example forms of implementing the disclosure. The subject matter described above is provided by way of illustration only and should not be construed as limiting. Furthermore, the subject matter is not limited to implementations that solve any or all disadvantages noted in any part of this disclosure. Various modifications and changes may be made to the subject matter described herein without following the example embodiments and applications illustrated and described, and without departing from the true spirit and scope of the present disclosure.

While some subject matter described herein is presented in the general context of program modules that execute on computer systems, those skilled in the art will recognize that other implementations may be performed in combination with other types of components and program modules. Generally, program modules include routines, programs, components, data structures and other types of structures that perform particular tasks or implement particular abstract data types. Moreover, those skilled in the art will appreciate that the subject matter described herein may be practiced on or in conjunction with other computing system configurations beyond those described below, including multiprocessor systems, microprocessor-based or programmable consumer electronics, minicomputers, mainframe computers, special-purposed hardware devices, network appliances and the like. The embodiments described herein may also be practiced in distributed computing environments, where tasks are performed by remote processing devices that are linked through a communications network. In a distributed computing environment, program modules may be located in both local and remote memory storage devices.

It will be further appreciated that the logical operations described herein as part of a method or routine may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts or modules. These operations, structural devices, acts and modules may be implemented in software, in firmware, in special purpose digital logic and any combination thereof. It should also be appreciated that more or fewer operations may be performed than shown in the figures and described herein. These operations may also be performed in parallel, or in a different order than those described herein.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

What is claimed is:

1. A computer-implemented method comprising steps of:
creating a pre-installed system template;
exporting, by a second computer system, customer-specific data from an enterprise system in a source computing environment;
writing, by the second computer system, the exported customer-specific data to a first set of files;
uploading, by the second computer system, the first set of files to an upload area of a target computing environment;
deploying, by a first computer system, the pre-installed system template in the target computing environment to create a shell system; and
importing, by the first computer system, the first set of files into the shell system to create a replicated enterprise system in the target computing environment.

2. The computer-implemented method of claim 1, wherein creating the pre-installed system template comprises:
installing a basic empty enterprise system on a reference system;
deleting database tables from the basic empty enterprise system; and
storing the basic empty enterprise system in the pre-installed system template.

3. The computer-implemented method of claim 2, wherein the basic empty enterprise system comprises an operating system, an RDBMS, an enterprise system runtime kernel component, a delivered repository, and delivered configuration.

4. The computer-implemented method of claim 3, wherein the delivered repository and the delivered configuration comprise components of an SAP enterprise software system.

5. The computer-implemented method of claim 1, where deploying the pre-installed system template in the target computing environment comprises:
exporting repository components and configuration from the enterprise system in the source computing system to a second set of files;
transferring the second set of files to the target computing environment; and
importing the second set of files into the shell system.

6. The computer-implemented method of claim 5, wherein the second set of files is transferred to the target computing environment along with the first set of files.

7. The computer-implemented method of claim 1, wherein the uploading of the first set of files to the target computing environment is performed in parallel with the exporting of the customer-specific data.

8. The computer-implemented method of claim 1, wherein the customer-specific data comprises customer-specific application data and customer-specific configuration.

9. The computer-implemented method of claim 8, wherein the exported customer-specific data comprises a subset of the customer-specific application data from the enterprise system in the source computing environment, the subset of the customer-specific application data selected based on semantic relationships in the data of the enterprise system.

10. The computer-implemented method of claim 1, further comprising compressing the exported customer-specific data before writing the data to the first set of files.

11. The computer-implemented method of claim 1, wherein one or more of an operating system and an RDBMS of the target computing environment are different from those of the source computing environment.

12. The computer-implemented method of claim 1, wherein the first computer system comprises high-performance storage, and wherein the replicated enterprise system is migrated from the first computer system to a longer-term operating environment for execution.

13. A computer-readable storage media encoded with computer-executable instructions that, when executed by a computer system, cause the computer system to:
deploy a pre-installed system template in a target computing environment to create a shell system, the pre-installed system template comprising an operating system, an RDBMS, and an enterprise system runtime kernel component;
export customer-specific application data and configuration from an enterprise system in a source computing environment;
write the exported customer-specific application data and configuration to a first set of files;
upload the first set of files to an upload area of a target computing environment;
deploy a pre-installed system template in the target computing environment to create a shell system, the pre-installed system template comprising an operating system, an RDBMS, and an enterprise system runtime kernel component; and
import the first set of files into the shell system to create a replicated enterprise system in the target computing environment.

14. The computer-readable storage media of claim 13, encoded with further computer-executable instructions that cause the computer system to:
export repository components and configuration from the enterprise system in the source computing system to a second set of files;
transfer the second set of files to the target computing environment; and
import the second set of files into the shell system.

15. The computer-readable storage media of claim 13, encoded with further computer-executable instructions that cause the computer system to select a subset of the customer-specific application data from the enterprise system in the source computing environment for export based on semantic relationships in the data of the enterprise system.

16. The computer-readable storage media of claim 13, encoded with further computer-executable instructions that cause the computer system to compress the exported customer-specific application data before writing the data to the first set of files.

17. The computer-readable storage media of claim 13, wherein the shell system is created on a high-performance computing system comprising high-performance storage, the first set of files is imported into the shell system on the high-performance computing system, and wherein the replicated enterprise system is migrated from the high-performance computing system to a longer-term operating environment for execution.

18. A system for performing a replication of an enterprise system from a source computing environment to a target computing environment, the system comprising:
one or more application servers connected by one or more networks, each of the one or more application servers comprising a processor and a memory;
an export tool residing in the memory of one of the one or more application servers and configured to cause the processor to
select a subset of customer-specific application data from the enterprise system in the source computing environment,
export the subset of the customer-specific application data and customer-specific configuration from the enterprise system in the source computing environment, and
write the exported subset of the customer-specific application data and the customer-specific configuration to a set of files;
an upload manager residing in the memory of one of the one or more application servers and configured to cause the processor to upload the set of files to an upload area of the target computing environment; and
an import tool residing in the memory of one of the one or more application servers and configured to cause the processor to import the set of files from the upload area into a shell system to create a replicated enterprise system in the target computing environment, the shell system created by deploying a pre-installed system template in the target computing environment.

19. The system of claim 18, wherein the pre-installed system template comprises an operating system, an RDBMS, and an enterprise system runtime kernel component.

20. The system of claim 18, wherein the shell system is created on a high-performance computing system comprising high-performance storage, the set of files is imported into the shell system on the high-performance computing system, and wherein the replicated enterprise system is migrated from the high-performance computing system to a longer-term operating environment in the target computing environment upon completion of the importing.
